(19) United States
(12) Patent Application Publication
(10) Pub. No.: US 2002/0019496 A1
(43) Pub. Date: Feb. 14, 2002

(54) Ligands for metal affinity chromatography

(76) Inventor: Gerald Pevow, Atlanta, GA (US)

Correspondence Address: Martin L. McGregor, McGregor & Associates, 26415 Oak Ridge Drive, Spring, TX, 77380, US

(21) Appl. No.: 09/920,684

(22) Filed: Aug. 2, 2001

Related U.S. Application Data
(60) Provisional application No. 60/223,538, filed on Aug. 4, 2000.

(51) Int. Cl. C07F 15/02; C08F 8/42

(52) U.S. Cl. 525/360; 435/4; 556/148

(57) ABSTRACT

The invention provides a metal chelate resin that comprises repeating units having the structure:

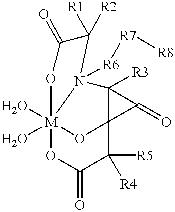

where M is a metal ion in an oxidation state capable of forming a complex with a tetradentate ligand having an overall coordination number of at least 6, R1, R2, R3, R4 and R5 are each hydrogen, halogen, straight-chain or branched alkyl, or alkenyl having 1 to 4 carbon atoms, halogenoalkyl having 1 or 2 carbon atoms and 1 to 5 fluorine, chlorine and/or bromine atoms, straight-chain or branched alkoxyalkyl having 1 to 3 carbon atoms in the alkoxy moiety and 1 to 3 carbon atoms in the alkyl moiety, alkylcarbonyl having 1 to 4 carbon atoms in the straight-chain or branched alkyl moiety, phenyl, or phenylcarbonyl, it being possible for each of the above mentioned phenyl radicals to be mono- to tri-substituted by identical or different substituents from the group consisting of fluorine, chlorine, bromine, cyano, nitro, alkyl having 1 or 2 carbon atoms, alkoxy having 1 or 2 carbon atoms, alkylthio having 1 or 2 carbon atoms, halogenoalkyl having 1 or 2 carbon atoms and 1 to 5 fluorine, chlorine and/or bromine atoms, halogenoalkoxy having 1 or 2 carbon atoms and 1 to 5 fluorine, chlorine and/or bromine atoms, halogenoalkylthio having 1 or 2 carbon atoms and 1 to 5 fluorine, chlorine and/or bromine atoms, provided that if R2, R3, R4 and R5 are all hydrogen R1 may not be hydrogen, R6 is a linking arm connecting the nitrogen atom of the ligand with R7 where R7 is a functional linking group through which the R6 linking arm is connected to R8 and R8 is an insoluble immobilization matix.

### RELATED APPLICATION

This application is a continuation of co-pending provisional application Ser. No. 60/223,538 filed Aug. 4, 2000.

### TECHNICAL FIELD

This application deals with ligands for metal affinity chromatography and specifically to N-carboxymethylasparate type immobilized ligands for chelation of metal ions.

### BACKGROUND OF THE INVENTION

Immobilized metal ion affinity chromatography was introduced by Porath (J. Porath, J. Carlsson, I. Olsson, G. Belfrage [1975]), Nature 258:598-599. This article and subsequent articles such as Porath, J. [1992] Protein Purification and Expression 3:263-281 describe immobilized metal ion affinity chromatography purification as a group-specific affinity technique for separating proteins. The principle is based on the reversible interaction between various amino acid side chains and immobilized metal ions. Depending on the immobilized metal ion, different side chains can be involved in the adsorption process. Most notably, the side chains of histidine, cysteine, and tryptophan amino acids have been implicated in protein binding to immobilized transition metals.

Various metal chelating ligands such as those incorporating iminodiacetic acid, nitrilotriacetic acid, and carboxymethylaspartate, and tris(carboxymethyl)ethylenediamine have been used for immobilized metal ion affinity chromatography purification of proteins. Each of these resins has very distinct disadvantages.

Iminodiacetic acid secures transition metals using three coordination sites and hence is referred to as a tridentate chelator. Since iminodiacetic acid uses only three coordination sites, it does not hold the metal tightly, thus leading to metal ion loss or leakage. Metal leakage leads to decreased binding capacity and may cause difficulties in downstream applications.

Both nitrilotriacetic acid and carboxymethylaspartate secure transition metals with four coordination sites and are called tetradentate chelators. Nitrilotriacetic acid, described in 1991 by Ford et al. (C. Ford, I. Suominen, C. Glatz Protein Expression and Purification 2:95-107), and carboxymethylaspartate described in 1989 by Mantovaara et. al (T. Mantovaara, H. Pertoft, J. Porath, Biotechnology and Applied Biochemistry 11:564-570) both have significant disadvantages. These ligands while securing transition metals more tightly than iminodiacetic acid, still experience metal leaking. Moreover, these ligands exhibit non-optimal interaction between metal ions and various amino acid side chains, most notably histidine-tagged proteins. This detrimental property leads to decreased specificity as well as decreased bonding capacity. Nevertheless, both ligands are available commercially; nitrilotriacetic acid through Qiagen, Inc. (Chatsworth, Calif.) and carboxymethylaspartate through CLONTECH Laboratories, Inc. (Palo Alto, Calif.), a wholly owned subsidiary of Becton, Dickinson and Company. Patents citing these molecules include:

U.S. Pat. No. 5,962,641 Nelson et al., U.S. Pat. No. 5,047,513 Dobeli et al., U.S. Pat. No. 4,877,830 Heinz et al. and EPO: 00253303 Heinz et al.

Other ligands such as tris(carboxymethyl)ethylenediamine have also been mentioned in the literature. tris(carboxymethyl)ethylenediamine is pentadentate, holding metal ions in place with 5 coordination sites. Tris(carboxymethyl)ethylenediamine forms a very strong metal-chelator complex, however, the disadvantage is that it leaves only one valence for protein interactions. Thus, proteins bind weakly to the metal, resulting in very low yields.

In contrast to the above ligands, the improved substituted tetradentate chelating ligands, described below, that complex transition metals in an octahedral arrangement using six coordination sites, an ideal geometry for purifying proteins, with two free coordination sites to complex with proteins. The improved ligands allow for high bonding capacity and high specificity, resulting in improved protein purity and yield. This improvement is due to the implementation of a control element in the form of a specific substitution group to maximize binding specificity for target proteins. The improved ligands may also be configured to hold the metal more tightly than other tri- and tetradentate chelators, reducing the quantity of metal leakage. The novel ligands as well as methods for synthesizing and utilizing the ligands are the subject of the invention described below.

### SUMMARY OF THE INVENTION

The invention provides a metal chelate resin that comprises repeating units having the structure:

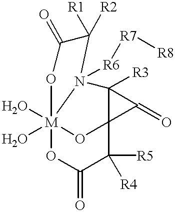

where M is a metal ion in an oxidation state capable of forming a complex with a tetradentate ligand having an overall coordination number of at least 6, R1, R2, R3, R4 and R5 are each hydrogen, halogen, straight-chain or branched alkyl, or alkenyl having 1 to 4 carbon atoms, halogenoalkyl having 1 or 2 carbon atoms and 1 to 5 fluorine, chlorine and/or bromine atoms, straight-chain or branched alkoxyalkyl having 1 to 3 carbon atoms in the alkoxy moiety and 1 to 3 carbon atoms in the alkyl moiety, alkylcarbonyl having 1 to 4 carbon atoms in the straight-chain or branched alkyl moiety, phenyl, or phenylcarbonyl, it being possible for each of the above mentioned phenyl radicals to be mono- to tri-substituted by identical or different substituents from the group consisting of fluorine, chlorine, bromine, cyano, nitro, alkyl having 1 or 2 carbon atoms, alkoxy having 1 or 2 carbon atoms, alkylthio having 1 or 2 carbon atoms, halogenoalkyl having 1 or 2 carbon atoms and 1 to 5 fluorine, chlorine and/or bromine atoms, halogenoalkoxy having 1 or 2 carbon atoms and 1 to 5 fluorine, chlorine and/or bromine atoms, halogenoalkylthio having 1 or 2 carbon atoms and 1 to 5 fluorine, chlorine and/or bromine atoms, provided that if R2, R3, R4 and R5 are all hydrogen R1 may not be hydrogen, R6 is a linking arm connecting the nitrogen atom of the ligand with R7 where R7 is a functional linking group through which the R6 linking arm is connected to R8 and R8 is an insoluble immobilization matrix. Examples of straight or branch chain alkyls having 1 to 4 carbons include methyl, ethyl, isopropyl, propyl, isobutyl, butyl, t-butyl. Examples of alkenyls having from 1 to 4 carbons include allyl, 1-methyl-2-propenyl, 3-butenyl, 2-butenyl, 3-methyl-2-butenyl, and 2-methyl-3-butenyl. Examples of halogenoalkyls include chloromethyl, dichloromethyl, trichloromethyl, mono, di or trifluoromethyl, chlorodifluoromethyl, mono, di, tri, tetra or pentafluoroethyl, mono, di, tri, tetra or pentachloroethyl, bromomethyl, iodomethyl and the like. Halogens are fluoro, chloro, bromo or iodo substitutents. Preferred resins according to the invention include those wherein R2, R3, R4, and R5 are each hydrogen, R1, R2, R4, and R5 are each hydrogen, R1, R2, R3, and R5 are each hydrogen, R3, R4, and R5 are each hydrogen, R2, R3, and R5 are each hydrogen, R2, R4, and R5 are each hydrogen, R1, R2, and R3 are each hydrogen, R3 and R5 are each hydrogen, R4 and R5 are each hydrogen, R1 and R2 are each hydrogen, R1 and R5 are each hydrogen, R1 is methyl, and R2, R3, R4, and R5 are hydrogen, R3 is methyl, and R1, R2, R4, and R5 are hydrogen, R4 is methyl, and R1, R2, R3, and R5 are, R1 and R2 are each methyl, and R3, R4, and R5 are hydrogen, R1 and R3 are each methyl, and R2, R4, and R5 are hydrogen, R1 and R5 are each methyl, and R2, R3, and R4 are hydrogen, R3 and R4 are each methyl, and R1, R2, and R5 are hydrogen.

The invention further includes use of a resin as described above to separate a protein from a mixture comprising a plurality of proteins. Another embodiment provides a method for selectively improving the metal ion binding of a resin as described above that comprises the steps of selecting groups for R1 through R5 to provide a first resin, measuring the metal ion binding capacity of the first resin, changing one selected group of R1 through R5 in a manner that effects the electronegativity of the metal ion to provide a second resin different from the first resin, measuring the metal ion binding of the second resin and comparing the measured value to the first resin. Alternatively the method may be applied for selectively improving the protein selectivity of a resin as described above that comprises the steps of selecting groups for R1 through R5 to provide a first resin, measuring the selectivity for binding a target amino acid sequence of the first resin, changing one selected group of R1 through R5 in a manner that effects the electronegativity of the metal ion to provide a second resin different from the first resin, measuring the selectivity for binding the same target amino acid sequence of the second resin and comparing the measured value to the first resin. Alternatively the method may be applied to selectively improving the metal ion binding of a resin as described above that comprises the steps of selecting groups for R1 through R5 to provide a first resin, measuring the metal ion binding capacity of the first resin, changing one selected group of R1 through R5 in a manner that effects the stereochemistry of the groups binding to the metal ion to provide a second resin different from the first resin, measuring the metal ion binding of the second resin and comparing the measured value to the first resin. And finally the invention provides a method for selectively improving the protein selectivity of a resin as described above that comprises the steps of selecting groups for R1 through R5 to provide a first resin, measuring the selectivity for binding a target amino acid sequence of the first resin, changing one selected group of R1 through R5 in a manner that effects the stereochemistry of the groups binding to the metal ion to provide a second resin different from the first resin, measuring the selectivity for binding the same target amino acid sequence of the second resin and comparing the measured value to the first resin.

### DETAILED DESCRIPTION OF THE INVENTION

### EXAMPLE 1

### Procedure for Synthesizing N-carboxydimethylmethylaspartylagarose in Large-scale

Sepharose CL-6B or CL-(Pharmacia, 8.0 L) is washed with distilled, deionized water (ddH20), suction dried, and transferred to a 22-L round bottom flask equipped with a mechanical stirring apparatus. Next, Epichlorohydrin (about 2.0 L) is added to the dried Sepharose creating a thick suspension upon mixing. The resin is then set aside at room temperature for 20 minutes. A solution of sodium hydroxide (about 560 g) and sodium borohydride (about 48 g) in approximately 6400 mL ddH₂O is added and the mixture is stirred overnight at ambient temperature. This creates an oxirane-derivatized resin which is subsequently collected by filtration and washed ten times with approximately 10 L ddH₂O for each wash. Following the ddH₂O wash, the oxirane-derivatized resin is washed once with about 10 L 10% sodium carbonate, suction dried, and transferred to a 22-L round bottom flask. For testing purposes to ensure that the oxirane concentration is sufficient (preferably >700 umol/g), a sample of the derivatized resin is treated with 1.3M sodium thiosulfate and titrated to approximately pH 7.0 and the oxirane concentration calculated by standard methods.

Add approximately 575 g of L-aspartic acid and 1700 g sodium carbonate to a solution of approximately 268 g sodium hydroxide in about 7.6 L ddH₂O, making sure to keep the temperature below approximately 25° C. Adjust the pH to approximately 11.0 and add the solution to the oxirane derivatized resin. Bring the reaction mixture to about 80° C. using a heating mantle and a mechanical stirrer. Maintain the temperature at 80° C. for about 4 hours and allow the reaction temperature to cool overnight at room temperature. Collect the resin by filtration and wash ten times with approximately 10 L ddH₂O. Then wash the resin once with about 10 L of 10% sodium carbonate and suction dry and transfer the resin to a 22-L round bottom flask equipped with a mechanical stirring apparatus.

Add about 3000 g of 2-bromo,-2-methylpropionic acid in approximately 750 g increments, to an ice-cooled solution of about 900 g sodium hydroxide in a 12 L ddH₂O, making sure that the temperature remains below approximately 30° C. Add approximately 660 g sodium carbonate to the solution to adjust the pH to about 10. Add the solution to the above resin and react the mixture overnight. Collect the resin by filtration and wash six times with approximately 10 L ddH₂O, six times with 10% acetic acid, and ten times with ddH₂O. Continue washing with ddH₂O until pH 6.0 is reached (tested with litmus paper). The N-carboxydimethylmethylaspartate chelating resin is then suction dried in preparation for metal loading.

Preparation of other compounds of the invention is carried out in the same manner with appropriately selected starting materials, for various substituents at the R1 and R2 positions, the appropriately substituted acetic acid analog is used. For example to provide R1=methyl, R2=ethyl one uses 2-bromo, 2-methyl, 2-ethyl acetic acid, (more properly named as 2 bromo-2-methylbutyric acid). Other starting materials such as 2-chloro-dimethylacetic acid, 2-chloropropionic acid, 2-bromo-2-methylacetic acid, 2-chloro-isobutyric acid, 2-bromo-isobutyric acid, 2-bromo-2-phenylacetic acid, 2-bromo-2(1,2,3-trichlorophenyl)acetic acid and the like are available to provide various substituents at the R1 and R2 positions. To provide various substituents at the R3 position one starts with an appropriate 2 substituted aspartic acid analog such as 2-methyl aspartic to provide R3=methyl, 2-phenyl-asparate R3=phenyl and so forth. To provide appropriately substituted compounds at the R4 and R5 positions one begins with an appropriate 3 substituted asparatic acid, for example 3-methyl aspartate provides R4=methyl, and 3,3 dimethylaspartic acid gives R4, R5 both =methyl. In a similar manner 3-phenyl-aspartic acid gives R4=phenyl and so on to provide any of the derivatives claimed. Alternatively various 3-substituted aspartic acid analogs maybe prepared by variation of the methods described by Gu U.S. Pat. No. 5,731,348 for alkyl glutamates as set out below.

### EXAMPLE 2

### Preparation of Various 3 Substituted Alkylaspartic Acid Analogs

In Scheme I, aspartic acid is esterified under standard conditions (March, “Advanced Organic Chemistry”, 4th Edition 1992, Wiley-Interscience Publication, New York) with an appropriate alcohol, such as methanol, ethanol, t-butanol or benzyl alcohol. The amine group of the diester product, is then protected under standard conditions, Buehler and Pearson, “Survey of Organic Synthesis”, 1970, Wiley-Interscience Publication, New York, by an appropriate amine protecting group, such as an aromatic amide such as nitrobenzoyl, naphthoyl, N-tert-butoxycarbonyl (BOC) or carbobenzyloxy (CBZ). The enolate of this fully protected aspartic acid, is prepared by reaction with a strong base, such as lithium bis(trimethylsilyl)amide or lithium diisopropylamide, in an inert solvent, such as tetrahydrofuran or ethyl ether, at a temperature range of −78.degree. to 0.degree. C. for 1 to 5 hr. The enolate is then reacted with an electrophile such as an alkylhalide, at a temperature between −78.degree. to −30.degree. C. for 0.5 to 24 hr to afford compounds of substituted in the R4, R5 position. The compounds described herein wherein R4 are alkyl, alkenyl, alkynyl, and cycloalkyl or alkylaryl are prepared from this procedure. The compounds described herein and their preparation will be understood further from the following non-limiting examples. In these examples, unless otherwise indicated, all temperatures are in degrees Celsius and parts and percentages are by weight. A variety of analogs of aspartic acid are synthesized, in particular, analogs of 3-alkyl-substituted aspartate. 3-methylaspartate has two chiral centers, resulting in four stereoisomers, as synthesized and isolated below.

### EXAMPLE 3

PART A: Preparation of N-(4-Nitrobenzoyl) R-Aspartic Acid Diethyl Ester

To a solution of 13.3 g (100 mmol) of D-aspartic acid in 150 mL of ethanol cooled to 0.degree. C., 11 mL (150 mmol) of thionyl chloride is added dropwise. The mixture is then heated until it becomes clear. The reaction mixture is then allowed to stir at room temperature for 48 hr. After evaporating the solvent, a clear oily residue is obtained which is carried on to the next step. The oily residue and 18.5 g (100 mmol) of 4-nitrobenzoyl chloride is stirred in 150 mL of methylene chloride and 20 mL of water. A 100 mL of 20% Na₂ CO₃ solution is slowly added. The reaction mixture is allowed to stir at room temperature for 3 hr. The organic phase is separated and after evaporating the solvent, the residue is crystallized from diethyl ether.

PART B: Preparation of N-(4-nitrobenzoyl)-3-Methyl Aspartic Acid Diethyl Ester

To a solution of 3.38 g (10 mmol) of N-(4-nitrobenzoyl)-Aspartic acid diethyl ester in 100 mL of anhydrous tetrahydrofuran which is cooled to −78.degree. C. under nitrogen, 22 mL (22 mmol) of 1.0M solution of lithium bis(trimethylsilyl)amide in THF is slowly added via syringe. The mixture is stirred at −78.degree. C. for 1 hr, then 40 mmol of iodomethane is added. The reaction mixture is then quenched with saturated ammonium chloride. After evaporating half of the solvent, the mixture is diluted with 200 mL of water and extracted with methylene chloride (3×50 mL). The combined extracts are washed with water, brine, and dried over MgSO₄. The solvent is evaporated and the oily residue purified through a column of silica gel, eluting with a mixture of ethyl acetate and hexanes (1:1) to yield about 1.6 g of oil.

PART C: Preparation of 3-Methyl Aspartic Acid

The product B above is refluxed in 50 mL of 6N HCl for 2 hr. and then cooled to room temperature. The precipitate is filtered and the filtrate is concentrated in vacuo. The residue is dissolved in 50 mL of distilled water and washed with 50 mL of 5% of trioctylamine in chloroform twice. The aqueous phase is concentrated in vacuo and the oily residue crystallized in acetone and water.

### EXAMPLE 4

### Preparation of 3,3-Dimethylaspartic Acid Diethyl Ester

Treating 33.8 g (100 mmol) of the product, 3-methylaspartic acid diethylester prepared as in 2B above, in the procedure for 2A above provides 3,3-dimethylaspartic acid diethyl ester, which may be converted to the free acid by hydrolysis as in part C above. In the same manner, the various other choices for R4 and R5 may be provided by substituting the appropriate electrophilic intermediate to provide the desired substituent.

### EXAMPLE 5

### Metal Loading of Resin Bound Ligand

A chelating resin prepared as in Example 1 (about 1 L of suction dried bed volume) is treated with a transition metal ion solution, e.g. 2 L of, for example either 200 mM of cobalt chloride hexahydrate, nickel sulfate hexahydrate, copper sulfate pentahydrate, or zinc chloride, according to the metal ion deserved. The resin is reacted with the 200 mM metal solution at room temperature for approximately 72 hours and then collected by filtration. The metal loaded chelating resin is washed five times with ddH₂O (about 1 L each), two times with 100 mM NaCl (about 1 L each), six times with ddH₂O (about 1 L each), and once with 20% aq. ethanol (about 1 L). The resin can be stored in 20% aq. ethanol.

Use of Metal Loaded Resins of the Invention in Protein Purification

The resin which is based upon a substituted N-carboxymethylaspartate metal chelating complex, can advantageously be used for purification of proteins, for example, recombinant proteins having a polyhistidine tail or “tag.”

According to one embodiment of the invention, a resin ligand, e.g., N-carboxydimethylmethylaspartate, is complexed to a metal ion, forming a complex. Preferably, the ligand used in the subject invention is complexed with one of the transition metals such as iron, nickle copper, zinc, cobalt and the like, preferably in the plus 2 oxidation state, and with octahedral geometry. The ligand is anchored to an immobilization support such as polymer matrices, e.g., agarose, polystyrene (as in microtiter plates), nylon (as in nylon filters), or the like. The polyhistidine tag possesses “neighboring” histidine residues which can advantageously allow the recombinant protein to bind to these transition metals in a cooperative manner to form very strong metal ion complexes. This cooperative binding refers to what is commonly known in the art as a “neighboring histidine effect.” For purposes of the subject invention, and as would be understood by a person of ordinary skill in the art, a “strong” or “very strong” metal ion complex refers to the bond strength between the metal ion and the chelating ligand. A strong or very strong metal ion complex, for example, allows little or essentially no metal leakage from the complex so that the purified protein, e.g., a recombinant protein having a polyhistidine tag, is not contaminated with extraneous metal ions.

The resin ligand metal complexes of the invention offers two available valencies that can form strong and but reversible metal complexes with two adjacent histidine residues on the surface of the recombinant protein. Another advantage to using the ligands of the invention is the ability to tailor the structure to strongly anchor the metal ion of choice whereby metal ion leaking can be virtually eliminated compared to metal leakage observed for other complex binding agents, e.g., Ni-IDA.

In a more preferred embodiment, Co2+ can be used as the transition metal with the resin ligands of the invention. The cobalt complexes are often less sensitive to reducing agents, such as .beta.-mercaptoethanol than other metals. Also, in many cases, cobalt complexes result in lower non-specific binding of contaminants. Metal ion leakage in cobalt complexes has been shown to remain low, even negligible, in the presence of up to 30 mM .beta.-mercaptoethanol.

One embodiment of the purification process of the subject invention is as follows:

1. Prepare lysate/sonicate containing recombinant 6× His protein according to standard procedures and techniques well known in the art.

2. Bind 6× His protein onto metal-loaded chelating resin at slightly basic pH, e.g., about pH 8.0.

3. Wash protein/resin complex at the same basic pH (about pH 8.0). Optional washes at a pH of about 7.0 or with imidazole additive can also be included.

4. Elute pure recombinant 6× His protein with an elution buffer having a pH of about 6.0-6.3 or, in the alternative, an elution buffer having a pH of about 8.0, plus about 40 to about 100 mM imidazole.

The subject process can be employed batchwise, in spin columns, in large-scale continuous-flow columns, and in high-flow rate columns (e.g., HPLC columns). Buffers used in the above procedures are standard buffers typically used in similar procedures, with appropriate adjustments and modifications made as understood in the art. For example, a high ionic strength buffer, e.g., 50 mM phosphate/10 mM Tris/100 mM NaCl can be used, with the pH adjusted as needed. The phosphate salt component can range from a concentration of 10-100 mM; Tris from 5-25 mM; and NaCl from 50-200 mM. Optimal elution conditions depend on the type of impurities, the amount of protein to be purified, and unique properties of the protein, and are determined on a case-by-case basis as would be readily recognized by a person of ordinary skill in the art.

Use of Resin to Select Optimum Resin Substituents for a Given Separtion

For general uses the resins according to the invention may be highly useful without optimization. However if a rare and expensive material such as a protein is needed in significant quantities it will be worthwhile to maximize the specificity of a resin for the particular target material. This is accomplished by systematically changing the substituent groups at R1 through R5 and measuring the binding of the target protein to the two resins then comparing the result. One then selects a different substituent at one position, makes the resin and tests the binding comparing the result to the previous result until a maximum is reached for that position. Next a second position is selected and the substituents varied until a maximum is found, the process being repeated at each of the sites R1 to R5 until and overall optimum specificity is achieved.

The same procedure may be employed to minimize metal leakage for a particular metal ion desired for a separation. Finally the optimum metal ion may be determined by systematically varying the chelated metal ion to determine which metal has the optimum specificity or yield for a particular separation.

We claim:

1. A metal chelate resin that comprises repeating units having the structure: 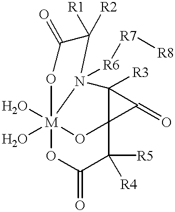
Where M is a metal ion in an oxidation state capable of forming a complex with a tetradentate ligand having an overall coordination number of at least 6, R1, R2, R3, R4 and R5 are each hydrogen, halogen, straight-chain or branched alkyl, or alkenyl having 1 to 4 carbon atoms, halogenoalkyl having 1 or 2 carbon atoms and 1 to 5 fluorine, chlorine and/or bromine atoms, straight-chain or branched alkoxyalkyl having 1 to 3 carbon atoms in the alkoxy moiety and 1 to 3 carbon atoms in the alkyl moiety, alkylcarbonyl having 1 to 4 carbon atoms in the straight-chain or branched alkyl moiety, phenyl, or phenylcarbonyl, it being possible for each of the above mentioned phenyl radicals to be mono- to tri-substituted by identical or different substituents from the group consisting of fluorine, chlorine, bromine, cyano, nitro, alkyl having 1 or 2 carbon atoms, alkoxy having 1 or 2 carbon atoms, alkylthio having 1 or 2 carbon atoms, halogenoalkyl having 1 or 2 carbon atoms and 1 to 5 fluorine, chlorine and/or bromine atoms, halogenoalkoxy having 1 or 2 carbon atoms and 1 to 5 fluorine, chlorine and/or bromine atoms, halogenoalkylthio having 1 or 2 carbon atoms and 1 to 5 fluorine, chlorine and/or bromine atoms, provided that if R2, R3, R4 and R5 are all hydrogen R1 may not be hydrogen, R6 is a linking arm connecting the nitrogen atom of the ligand with R7 where R7 is a functional linking group through which the R6 linking arm is connected to R8 and R8 is an insoluble immobilization matrix.

2. A resin of claim 1 wherein R2, R3, R4, and R5 are each hydrogen.

3. A resin of claim 1 wherein R1, R2, R4, and R5 are each hydrogen.

4. A resin of claim 1 wherein R1, R2, R3, and R5 are each hydrogen.

5. A resin of claim 1 wherein R3, R4, and R5 are each hydrogen.

6. A resin of claim 1 wherein R2, R3, and R5 are each hydrogen.

7. A resin of claim 1 wherein R2, R4, and R5 are each hydrogen.

8. A resin of claim 1 wherein R1, R2, and R3 are each hydrogen.

9. A resin of claim 1 wherein R3 and R5 are each hydrogen.

10. A resin of claim 1 wherein R4 and R5 are each hydrogen.

11. A resin of claim 1 wherein R1 and R2 are each hydrogen.

12. A resin of claim 1 wherein R1 and R5 are each hydrogen.

13. A resin of claim 1 wherein R1 is methyl, and R2, R3, R4, and R5 are hydrogen.

14. A resin of claim 1 wherein R3 is methyl, and R1, R2, R4, and R5 are hydrogen.

15. A resin of claim 1 wherein R4 is methyl, and R1, R2, R3, and R5 are hydrogen

16. A resin of claim 1 wherein R1 and R2 are each methyl, and R3, R4, and R5 are hydrogen.

17. A resin of claim 1 wherein R1 and R3 are each methyl, and R2, R4, and R5 are hydrogen.

18. A resin of claim 1 wherein R1 and R5 are each methyl, and R2, R3, and R4 are hydrogen.

19. A resin of claim 1 wherein R3 and R4 are each methyl, and R1, R2, and R5 are hydrogen.

20. The use of a resin of claim 1 to separate a protein from a mixture comprising a plurality of proteins.

21. A method for selectively improving the metal ion binding of a resin according to claim 1 that comprises the steps of selecting groups for R1 through RS to provide a first resin, measuring the metal ion binding capacity of the first resin, changing one selected group of R1 through R5 in a manner that effects the electronegativity of the metal ion to provide a second resin different from the first resin, measuring the metal ion binding of the second resin and comparing the measured value to the first resin.

22. A method for selectively improving the protein specificity of a resin according to claim 1 that comprises the steps of selecting groups for R1 through R5 to provide a first resin, measuring the selectivity for binding a target amino acid sequence of the first resin, changing one selected group of R1 through R5 in a manner that effects the electronegativity of the metal ion to provide a second resin different from the first resin, measuring the selectivity for binding the same target amino acid sequence of the second resin and comparing the measured value to the first resin.

23. A method for selectively improving the metal ion binding of a resin according to claim 1 that comprises the steps of selecting groups for R1 through R5 to provide a first resin, measuring the metal ion binding capacity of the first resin, changing one selected group of R1 through R5 in a manner that effects the stereochemistry of the groups binding to the metal ion to provide a second resin different from the first resin, measuring the metal ion binding of the second resin and comparing the measured value to the first resin.

24. A method for selectively improving the protein selectivity of a resin according to claim 1 that comprises the steps of selecting groups for R1 through R5 to provide a first resin, measuring the selectivity for binding a target amino acid sequence of the first resin, changing one selected group of R1 through R5 in a manner that effects the stereochemistry of the groups binding to the metal ion to provide a second resin different from the first resin, measuring the selectivity for binding the same target amino acid sequence of the second resin and comparing the measured value to the first resin.
